(19) United States
(12) Patent Application Publication
(10) Pub. No.: US 2007/0235270 A1
(43) Pub. Date: Oct. 11, 2007

(54) INSERT FOR MANUFACTURE OF AN ENHANCED SOUND DAMPENING COMPOSITE ROTOR CASTING AND METHOD THEREOF

(75) Inventors: Gregory Miskinis, Waupaca, WI (US); Jon Ernst, Scandinavia, WI (US); Richard Madson, Amherst, WI (US)

Correspondence Address: GIFFORD, KRASS, SPRINKLE,ANDERSON & CITKOWSKI, P.C, PO BOX 7021, TROY, MI, 48007-7021, US

(73) Assignee: THYSSENKRUPP-WAUPACA DIVISION, Waupaca, WI (US)

(21) Appl. No.: 11/734,095

(22) Filed: Apr. 11, 2007

Related U.S. Application Data
(60) Provisional application No. 60/791,029, filed on Apr. 11, 2006.
(60) Provisional application No. 60/826,414, filed on Sep. 21, 2006.
(60) Provisional application No. 60/862,901, filed on Oct. 25, 2006.
(60) Provisional application No. 60/864,430, filed on Nov. 6, 2006.
(60) Provisional application No. 60/885,419, filed on Jan. 18, 2007.

(51) Int. Cl. F16D 65/12

(52) U.S. Cl. 188/218 XL

(57) ABSTRACT

An insert for a casting mold used to produce a sound dampening rotor of a caliper disc brake is provided. The insert includes a ring having an inner diameter, an outer diameter and at least one tab. The insert also includes an inner core made from a refractory material, the inner core being adjacent to the ring. The tab of the ring is operable to position the ring relative to the inner core. Furthermore, the ring and the inner core together can be placed within the casting mold and afford for the desirable and accurate placement of the sound dampening ring within a cast sound dampening composite rotor of a caliper disc brake.

### CROSS-REFERENCE TO RELATED APPLICATIONS

This application claims priority of U.S. Provisional Patent Application Ser. Nos. 60/791,029 filed Apr. 11, 2006; 60/826,414 filed Sep. 21, 2006; 60/862,901 filed Oct. 25, 2006; 60/864,430 filed Nov. 6, 2006; and 60/885,419 filed Jan. 18, 2007, which are incorporated herein by reference.

### FIELD OF THE INVENTION

This invention relates generally to an insert for a casting. More specifically, the invention relates to an insert for an enhanced sound dampening composite rotor casting.

### BACKGROUND OF THE INVENTION

Brake squeal is caused by high frequency vibrations created by the interaction of friction pads and disc brake rotors. Repetitive vibrations of the friction pads rubbing against the surface of the rotor creates harmonic vibrations in the rotor, thereby causing the rotor to ring like a cymbal, with the greater the amplitude of the vibrations, the louder the brake squeal. Traditional methods to reduce the harmonic vibration exhibited by rotors have included: (1) changing the shape and material used to form the rotor and/or brake pads; and (2) the inclusion of pads or shims to isolate or dampen the vibrations between the pads and the rotor. Thus far, these methods have obtained limited success. Therefore, it would be advantageous to have a brake rotor with improved sound dampening characteristics, wherein a dampening ring is included within the casting. However, the placement of an enhanced sound dampening ring within a mold that will produce an enhanced sound dampening composite rotor is a difficult and complicated task. Therefore, an insert to position the dampening ring within the mold used to produce the enhanced sound dampening composite rotor is desired.

### SUMMARY OF THE INVENTION

An insert for a casting mold used to produce a sound dampening rotor of a caliper disc brake is provided. The insert includes a ring having an inner diameter, an outer diameter and at least one tab. The insert also includes an inner core made from a bonded sand or a refractory material, the inner core being adjacent to the ring. The at least one tab of the ring is operable to position the ring relative to the inner core. Furthermore, the ring and the inner core together can be placed within the casting mold and afford for the desirable and accurate placement of the sound dampening ring within a cast sound dampening composite rotor casting.

The ring can be made from any material known to those skilled in the art, illustratively including a metallic material, a ceramic material and combinations thereof. The ring material has a higher melting point than a melting point of a rotor material cast about the ring. In addition, the ring can include a coating wherein the coating is made from a metallic material dissimilar to the ring, a ceramic material dissimilar to the ring and combinations thereof. The ring can be treated before being placed adjacent to the inner core, the treatment of the ring including smoothing the edges of the ring, stiffening the ring, enhancing radial expansion of the ring and/or forming an interfacial boundary on the ring surface. The ring can be fixedly attached to the core using integral fasteners, external fasteners and combinations thereof. In addition, the ring and core assembly can be preheated before placing the assembly into a casting mold.

The insert can be a manufactured-in-place insert wherein the dampening ring and inner core are assembled at one station or general location within a plant such as a foundry. In one instance, the insert can be made using a blow-in-place core wherein the dampening ring is placed within a core box and the core is blown around said ring. In another instance, a manufactured-in-place insert includes a blow-in-place core that has at least one cavity region on an outer circumference which affords for desirable placement of the ring with respect to the core. The inner core also can also have at least one channel which can be used to afford for the desirable placement of the ring. The inner core is preferably made from silica sand, wherein the silica sand is bonded using a bonding agent such as heat, cold cured bonding agents and combinations thereof

### BRIEF DESCRIPTION OF THE DRAWINGS

FIG. 1 is a perspective view of the insert of one embodiment of the present invention;

FIG. 2 is a perspective view of the embodiment shown in FIG. 1 after a rotor has been cast thereon;

FIG. 3 is a perspective view of a completed casting including the sound dampening ring of the present invention;

FIG. 4 is a top view of the casting shown in FIG. 3;

FIG. 5 is a cross-sectional view of section 5-5 shown in FIG. 4;

FIG. 6 is a top view of a different embodiment of the present invention;

FIG. 7 is a perspective view of a dampening ring with inter-vane tabs;

FIG. 8 is a cross-sectional view of section 8-8 shown in FIG. 6 showing an inter-vane tab located between two vanes;

FIG. 9 is a perspective view of a section of a dampening ring with vane-straddle tabs;

FIG. 10 is a cross-sectional view illustrating a vane-straddle tab straddling two vanes;

FIG. 11 is a perspective view of another embodiment of the present invention; and

FIG. 12 is a flow chart representing the treatment of a ring before placement adjacent to an inner core.

### DETAILED DESCRIPTION OF THE INVENTION

The present invention comprises a cast-in-place insert and a method for the manufacture of an enhanced sound dampening rotor. As such, the present invention has utility as an insert for, and a method of producing castings, as well as improving die reliability and quality of a cast rotor.

The cast-in-place insert of the present invention includes a sound dampening ring and an inner core. The inner core can be made from sand, the sand bonded to make the core using a bonding agent such as heat, cold cured bonding agents and combinations thereof. In one instance, the inner core is made from silica sand. The inner core can have at least one channel which affords placement of the sound dampening ring at least partially therein. The core can also include a plurality of vanes which afford for a vented sound dampening rotor. The ring includes at least one tab, the tab affording assistance in placing the ring adjacent to the inner core.

Referring now to FIG. 1, a perspective view of one embodiment of the present invention is shown generally at 10. The cast-in-place insert shown at 10 includes a sound dampening ring 100 and an inner core 200. The sound dampening ring 100 includes at least one tab 110, an outer diameter 120 and an inner diameter 130.

It is appreciated that for purposes of the present invention, the term “core” “inner core” is equivalent to the term “fin core” or “vane core” when the core is used to produce a ventilated rotor. In addition, the term “core” or “inner core” is used interchangeably with the term “ring core” when the core is used to produce a non-ventilated rotor. It is also appreciated that the insert of the present invention can be a manufactured-in-place insert wherein the dampening ring and inner core are assembled at one station or general location within a plant such as a foundry. In one instance, the insert can be made using a blow-in-place core wherein the dampening ring is placed within a core box and the core is blown around said ring.

The inner core 200 includes a hub region 210, a disc region 220, at least one channel or indentation 230, and optionally a vane region 240. The inner core 200 can also include a second disc region 222, however this is not required. The channel region 230 affords for the dampening ring 100 to fit at least partially within and thus assists in the desirable placement of the ring 100 adjacent to the inner core 200.

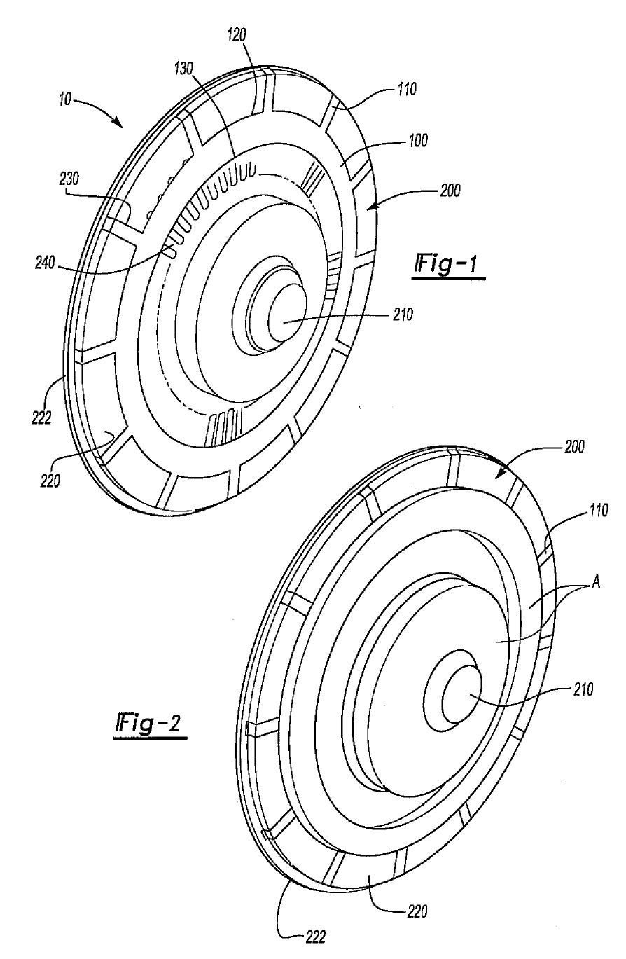

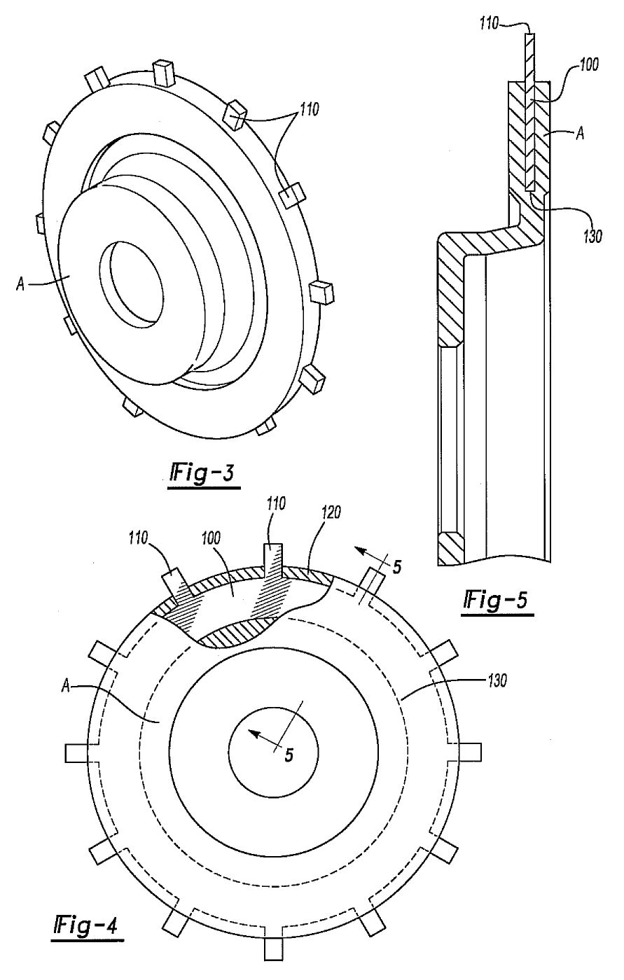

Upon placing tie cast-in-place insert 10 within a casting mold and pouring molten metal into the mold and around the cast-in-place insert 10, a sound dampening composite rotor can be produced as shown in FIG. 2. The casting A in combination with the sound dampening ring 100 provides for enhanced sound dampening of a caliper disc brake. The embodiment shown in FIG. 2 illustrates the inner core 200 still present after the casting A with insert 10 has been removed from the casting mold. Subsequent operations such as a “shakeout” operation can remove the inner core material and affords for a cast rotor with a dampening ring therein. FIG. 3 illustrates such a rotor wherein casting A has dampening ring 100 with at least one tab 110 therein.

The dampening ring 100 is limitedly fused or unfused with the casting A and includes a similar or dissimilar metallic material and/or ceramic material which provides an interfacial layer between the ring 100 and the casting A. The interfacial layer affords for coulomb friction dampening between the casting A and the dampening ring 100. An interfacial layer provided by a coating of ceramic material on the ring 100 can be omitted from at least a portion of said ring 100. The absence of the ceramic material on any portion of the ring 100 can result in the uncoated portion of the ring that is in contact with the casting A to be fused to said casting. In one instance, a ceramic material is applied to a dampening ring 100, except for the tabs 110. The uncoated portion of the tabs 110 that comes into contact with molten metal used to form casting A is fused to said casting.

The dampening ring 100 is made from a material with a higher melting point than a melting point of the casting A material such that the dampening ring 100 resists melting when the molten metal producing the casting A is poured into the mold and comes into contact with said ring 100. In addition, the dampening ring 100 can be coated with a dissimilar metallic material and/or ceramic material in order to provide an interfacial boundary between the casting A and dampening ring 100. For purposes of the present invention, the term “metallic material” includes metals and alloys, and the term “ceramic material” includes oxides, nitrides, carbides, borides and combinations thereof

Turning to FIGS. 4 and 5, FIG. 4 illustrates a top view of the embodiment shown in FIG. 3 wherein a cut out region provides a view of the dampening ring 100 within the casting A. FIG. 5 provides a cross-sectional view of the section 5-5 illustrated in FIG. 4. As shown in these two figures, the present invention affords for a dampening ring 100 within a casting A and thereby provides an enhanced sound dampening composite rotor for caliper disc brakes. As mentioned above, the dampening ring 100 is made from a material such that pouring of the molten metal around the cast-in-place insert 10 does not melt the ring 100 and thereby results in a separate and distinct component, and an interface, between casting A and ring 100.

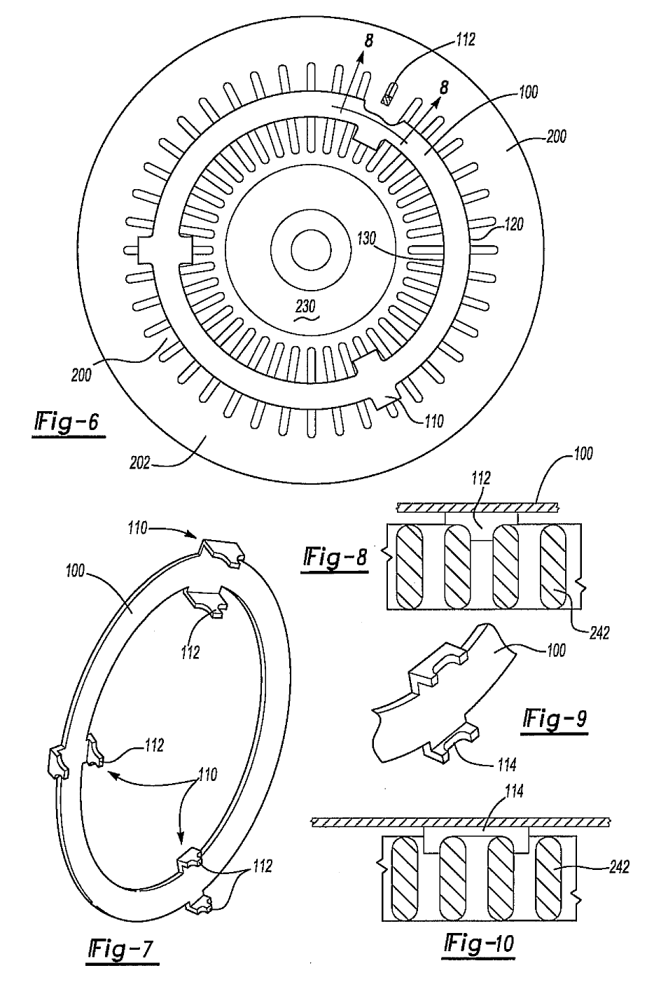

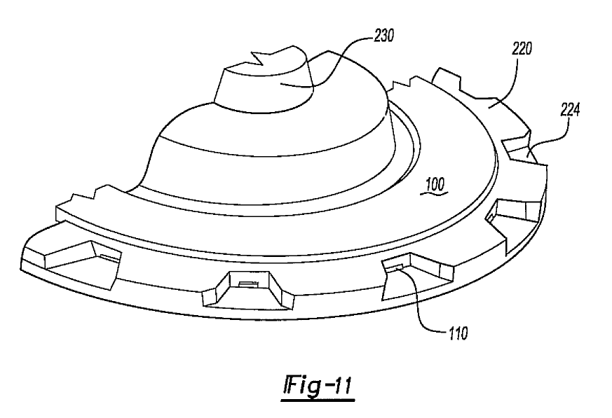

A different embodiment of the present invention is illustratively shown in FIGS. 6-10. This embodiment uses at least one tab 110 that affords for the placement of the ring 100 with respect to the inner core 200 and the vane region 240 using, for example, inter-vane tabs 112 and/or vane-straddle tabs 114. As shown in FIGS. 7 and 8, the tab 110 can be in the shape of an inter-vane tab 112 which fits between vanes 242 present in the vane region 240. In the alternative, a vane-straddle tab 114 can be used to position the dampening ring 100 adjacent to the inner core 200 as illustrated in FIGS. 9 and 10. It is appreciated that although FIGS. 6-10 illustrate inter-vane tabs 112 and vane-straddle-tabs 114, these tab shapes and designs are for illustrative purposes only and are not meant to limit the scope of the present embodiment. Therefore, other shapes and/or designs that afford for tie placement of the ring 100 with respect to the inner core 200 are within the scope of the present invention. In addition, although FIGS. 6, 7 and 9 illustrated the tabs 110 extending beyond the outer diameter 120 and inner diameter 130 of the ring 100, this is not required. The tabs 112 and/or tabs 114 can be flush or even with the outer diameter 120 and/or inner diameter 130. In this manner, the tab 110 does not necessarily extend beyond the outer diameter of the inner core 200. Furthermore, this embodiment illustrates that a channel region 230 is not required in the inner core 200 in order for the desirable placement of the ring 100 adjacent to the inner core 200.

Yet another embodiment of the present invention is shown in FIG. 11. In this embodiment, the inner core 200 has a disc region 220 with at least one cavity region 224. The cavity region 224 is a region wherein sand is not present and affords for the viewing of the outer diameter 120 and/or tab 110 of the dampening ring 100. It is appreciated that by affording for the viewing of at least part of the dampening ring 100 at the cavity region 224, desirable alignment and placement of the ring 100 adjacent to the inner core 200 is assured.

The ring 100 can also be attached to an inner core by integral or separate attachments which suspend and secure the ring in a desired position and thereby afford placement in a vertically or horizontally divided mold. Such a ring attachment and/or fastener can be any attachment means and/or fastener known to those skilled in the art, illustratively including wire ties, clips, band fasteners, washer type push fasteners, twist fasteners, formed in place lock tabs and combinations thereof.

Another embodiment affords for the production of more than one enhanced sound dampening composite rotor A for a single pour/casting. The embodiment includes a fin core and a splitter core as part of the inner core 200. The fin core affords for the casting of a vented rotor and the splitter core affords for the separation of two or more castings within one mold. In one instance, the fin core affords for the casting of two hub side disc surfaces and the splitter core affords for two non-hub side disc brake surfaces. In the alternative, the fin core can afford for two non-hub side disc brake surfaces and the splitter core affords for the casting of two hub side disc surfaces. In so doing, this embodiment allows affords for two or more castings A to be produced with one pour. It is appreciated that the features and aspects of the dampening ring 100 and inner core 200 described in the prior embodiments can be included in this embodiment.

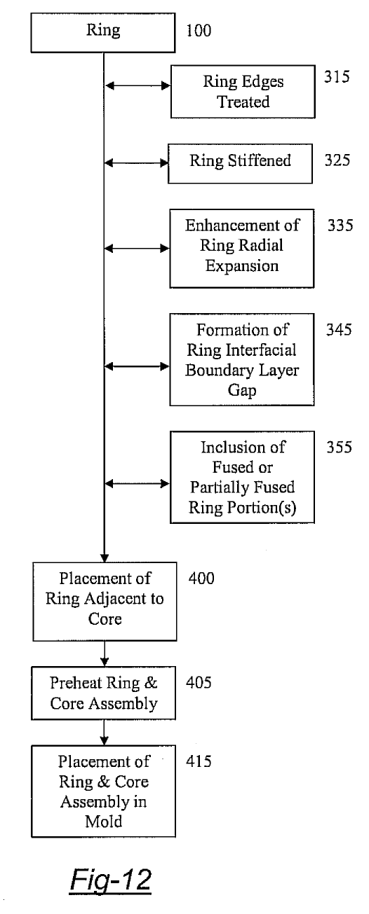

Preferably, the dampening ring 100 is treated before being placed adjacent to the inner core 200. Turning to FIG. 12, possible steps of a method to treat the dampening ring 100 are illustrated. As shown at step 315, the edges of the dampening ring 100 can be treated in order to eliminate sharp corners. Sharp corners can interfere with coatings applied to the dampening ring 100 and cause fusion of the ring to the body of the casting A. The edges of the dampening ring 100 can be rolled, burnished or coined to eliminate the sharp corners. In the alternative, the dampening ring edges can be treated using acid dipping, abrasive blasting or media honing in order to blunt said edges.

The dampening ring 100 can be stiffened (step 325) by roll beading or die forming in a circumferential or radial direction of the ring. In addition, orientations of roll beading or die forming can be contrary to the circumferential or radial direction in order to impart a special modal response on the dampening ring and/or the dampening ring/inner core assembly. Enhancement of the dampening ring 100 radial expansion can be accomplished by inclusion of expansion slots formed by laser, water jet or other mechanical means at step 335. The orientation of the slots can be in a circumferential or radial direction. In the alternative, the orientation of the slots may be contrary to the circumferential or radial direction in order to impart a specific modal response.

Turning to step 345, an interfacial boundary layer gap can be formed between the dampening ring 100 and the molding media of the inner core 200 by application of a refractory or ceramic base coating onto the ring 100. The coating can be applied to the dampening ring 100 by dipping, brushing, spraying, electrostatic deposition and combinations thereof. Fused ceramics can be used for the coating, illustratively including recrystallized silicon carbide, aluminum oxide, magnesium oxide, zirconium boride, zirconium carbide, hafnium boride, hafnium carbide, hafnium nitride, tantalum carbide and combinations thereof. The dampening ring 100 can also include a fused or partially fused portion or portions to reinforce and/or lighten specific areas of the insert 10 at step 355. Specifically, the web area between the brake rubbing surfaces and the wheel-end mounting surface can include a fused or partially fused portion. In the alternative the ring 100 can be used to replace the entire cast wheel-end mounting portion of the brake disc.

The ring is placed adjacent to the core at step 400 and the dampening ring and core assembly can be preheated at step 405 before placing the assembly in a casting mold at step 415. The ring and core assembly can be preheated to a given temperature, delta, above that of the molding material in order to prevent the formation of gas, which can then result in condensation. In addition, the preheating can minimize and/or prevent a dissimilar microstructure at the cast rotor/dampening ring interface, especially iron carbide and under-cooled graphite when molten cast iron is poured into a mold and comes into contact with the ring 100. The preheating can be accomplished using microwave, convection, resistance, induction, infrared and/or forced air techniques in a suitably sized cabinet or chamber. The heating method can be dependent on the geometry of the dampening ring 100.

Although FIG. 12 illustrates the various treatments accomplished in a specific order, this need not be the case for the present invention to be operative. For example, the dampening ring 100 can be stiffened at step 325, followed by treating the edges at step 315, followed by formation of a ring interfacial boundary layer gap at step 345 before placement of the dampening ring 100 adjacent to the inner core 200 at step 400. Furthermore, one or more of the processes shown in FIG. 12 can be executed more than once upon a given dampening ring 100 or eliminated entirely.

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented therein. It is the following claims, including all equivalents, which define the scope of the invention.

We claim:

1. An insert for a casting mold for a sound dampening rotor of a caliper disc brake comprising:
a ring having an inner diameter, an outer diameter and at least one tab; and
an inner core made from a bonded sand material, said inner core adjacent to said ring;
said tab operable to position said ring relative to said inner core;
said ring and said inner core dimensioned to be placed within a casting mold.

2. The insert of claim 1, wherein said at least one tab extends in a generally outward direction from said outer diameter.

3. The insert of claim 1, wherein said at least one tab extends in a generally inward direction from said inner diameter.

4. The insert of claim 1, wherein said ring is made from a material selected from the group consisting of a metallic material, a ceramic material and combinations thereof.

5. The insert of claim 4, wherein said ring material has a higher melting point than a melting point of a rotor material cast about said ring.

6. The insert of claim 4, wherein said ring has a coating, said coating selected from the group consisting of recrystallized silicon carbide, aluminum oxide, magnesium oxide, zirconium boride, zirconium carbide, hafnium boride, hafnium carbide, hafnium nitride, tantalum carbide and combinations thereof, for the purpose of providing an interfacial boundary between said ring and a casting.

7. The insert of claim 1, wherein said ring is treated before being placed adjacent to said inner core.

8. The insert of claim 7, wherein said treatment is selected from the group consisting of smoothing edges of said ring, stiffening said ring, enhancing radial expansion of said ring, forming an interfacial boundary on said ring and combinations thereof.

9. The insert of claim 1, further comprising fasteners, said fasteners fixedly attaching said ring to said inner core.

10. The insert of claim 9, wherein said fasteners are selected from the group consisting of integral fasteners, external fasteners and combinations thereof.

11. The insert of claim 9, wherein said fasteners are selected from the group consisting of wire ties, clips, band fasteners, washer type push fasteners, twist fasteners, formed in place lock tabs and combinations thereof.

12. The insert of claim 1, wherein said insert is a manufactured-in-place insert.

13. The insert of claim 12, wherein said insert is made with a blow-in-place core.

14. The insert of claim 13, wherein said inner core has a cavity region on an outer circumference of said inner core, said cavity region operable to allow desirable placement of said ring adjacent to said inner core.

15. The insert of claim 1, wherein said inner core has a channel, said channel operable to allow said ring to be placed at least partially therein.

16. The insert of claim 1, wherein said inner core has a plurality of vanes, said vanes operable to produce a vented sound dampening rotor.

17. The insert of claim 1, wherein said inner core is comprised of silica sand, said silica sand bonded to form said inner core using a bonding agent selected from the group consisting of heat, cold cured bonding agents and combinations thereof.

18. The insert of claim 1, wherein said tab is a vane straddle tab.

19. The insert of claim 1, wherein said tab is an inter-vane tab.

20. The insert of claim 1, wherein said ring comprises the entire cast wheel-end portion of a brake disc.

21. A method for manufacturing an insert for a casting mold for a sound dampening composite rotor of a caliper disc brake comprising the steps of:
preparing a sound dampening ring for placement adjacent to an inner core;
placing the sound dampening ring and inner core adjacent to each other; and
placing the sound dampening ring and the inner core into the mold.

22. The method of claim 21, wherein the ring is made from a material selected from the group consisting of a metallic material, a ceramic material and combinations thereof.

23. The method of claim 22, wherein the ring material has a higher melting point than a melting point of a rotor material cast about said ring.

24. The method of claim 22, wherein the ring has a coating, the coating selected from the group consisting of recrystallized silicon carbide, aluminum oxide, magnesium oxide, zirconium boride, zirconium carbide, hafnium boride, hafnium carbide, hafnium nitride, tantalum carbide and combinations thereof.

25. The method of claim 21, wherein preparing the sound dampening ring is selected from tie group consisting of smoothing edges of the ring, stiffening the ring, enhancing radial expansion of the ring, forming an interfacial boundary on the ring and combinations thereof.

26. The method of claim 21, further providing fasteners, the fasteners fixedly attaching the ring to the inner core.

27. The method of claim 26, wherein the fasteners are selected from the group consisting of integral fasteners, external fasteners and combinations thereof.

28. The method of claim 26, wherein the fasteners are selected from the group consisting of wire ties, clips, band fasteners, washer type push fasteners, twist fasteners, formed in place lock tabs and combinations thereof.

29. The method of claim 21, wherein the insert is a manufactured-in-place insert.

30. The method of claim 29, wherein the insert includes a blow-in-place core.

31. The method of claim 30, wherein the inner core has a cavity region on an outer circumference of the inner core, the cavity region operable to allow desirable placement of the ring adjacent to the inner core.

32. The method of claim 21, wherein the inner core has a channel, the channel operable to allow the ring to be placed at least partially therein.

33. The method of claim 21, wherein the inner core has a plurality of vanes, the vanes operable to produce a vented sound dampening rotor.

34. The method of claim 21, wherein the inner core is comprised of silica sand, the silica sand bonded to form the inner core using a bonding agent selected from the group consisting of heat, cold cured bonding agents and combinations thereof.

35. The insert of claim 21, wherein said tab is a vane straddle tab.

36. The insert of claim 21, wherein said tab is an inter-vane tab.
